(19) United States
(12) Patent Application Publication
(10) Pub. No.: US 2015/0199765 A1
(43) Pub. Date: Jul. 16, 2015

(54) Insurance recommendation computer system and method

(71) Applicant: Simon John Noonan, Beverly Hills, CA (US)

(72) Inventor: Simon John Noonan, Beverly Hills, CA (US)

(21) Appl. No.: 14/623,267

(22) Filed: Feb. 16, 2015

(51) Int. Cl. G06Q 40/08

(52) U.S. Cl. CPC G06Q 40/08

(57) ABSTRACT

An insurance recommendation computer system and method to create insurance recommendations for individuals taking into account the circumstances of their household. Data inputs are gathered from the user which allow the user to generate recommendations that enhance their ability to understand and buy insurance coverage appropriate to their needs. Each recommendation generated falls into one of 277 categories. It has been implemented using C# code on a computer running Microsoft Windows and for typical household the generation or regeneration of ideas using the latest data takes 1 second or thereabouts. The system and method is designed to get the user up and running quickly by pre-populating almost all data elements except the user's email and password, and encourages the user to iterate through inputting data and updating the recommendations repeatedly by providing more information and illustration in the recommendations than in the questions around data inputs.

### BACKGROUND

Few people look forward to purchasing or renewing their insurance policies. Insurance is expensive, and the purchase process is time consuming and riddled with technical jargon that few people fully understand. For example the percentage of the adult population that can accurately describe what underinsured motorists property damage liability insurance covers is likely under 1%. Between 10-15% of the US driving population is uninsured despite mandatory auto insurance statutes almost everywhere and a majority of homes are underinsured. Many households with an income or assets that are sufficiently large that purchasing an umbrella policy would be prudent do not, despite the fairly low cost of these policies. At the same time, many households shop infrequently for more appropriate coverage and lower premiums and when they do, a typical effort would involve getting quotes from only 2-3 insurers. Insurance companies generally make a lot more money on customers that have been around for several years than on new customers and if those customers were better organized in their shopping efforts, they could likely get coverage better suited to their needs and save money.

### EXAMPLE OF RECOMMENDATIONS FOR A HOUSEHOLD

Exhibit 1 shows an overview of the C# code implementation of this system and method for a hypothetical household (Lucy, her husband David and child Valentina), including home page, household data summary screen (MyInfo), a screen for editing the attributes of the Lucy household, a screen for editing the attributes of an individual (David), a screen for editing the attributes of a residence (101 Rue), a screen for editing the attributes of an auto (Ford-2014), the start of a screen for editing a homeowners policy, a screen for editing the attributes of a life policy (for David), a screen for net promoter score information for an insurer, and last but not least, the start of the recommendations created by the system and method for this household given the data entered. Exhibit 2 shows a complete listing of the recommendations created for Lucy's household.

### OVERVIEW OF RECOMMENDATIONS CREATED BY THE SYSTEM AND METHOD

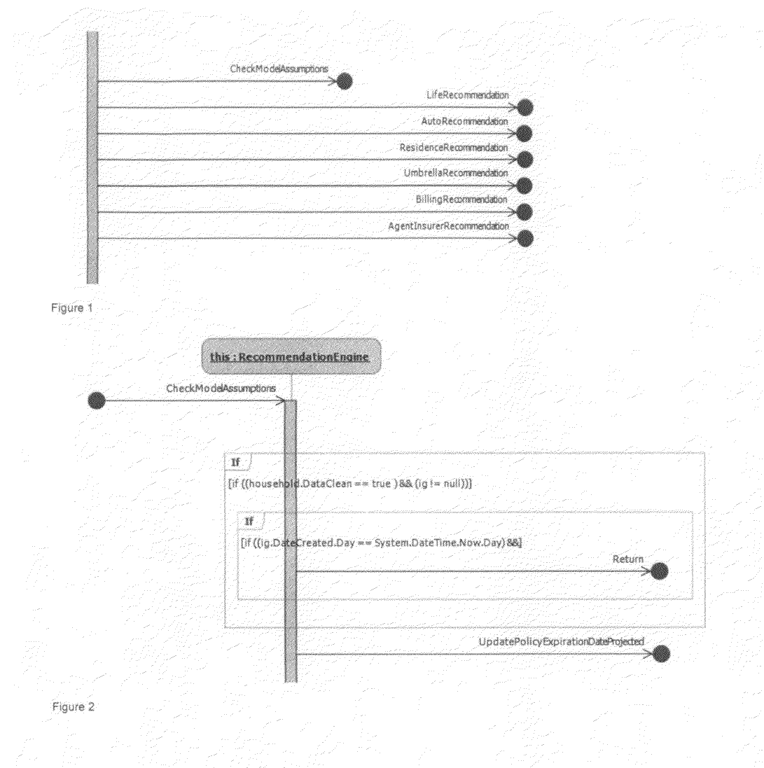

There are 277 types of recommendation created by the system and method. An example of each is shown in Exhibit 4 using dummy data for 26 hypothetical households. In the table below, “code” essentially defines a category of recommendation and for each code there are one or more “sub-codes” that refine the code into one or more mutually exclusive scenarios leading to a recommendation.

| | | | Number |
|---|---|---|---|
| | | | Of Code/ |
| Code | | Number | Sub Code |
| Category | | Codes | Combinations |
| [1] | Description | [2] | [3] |
| 2 | Property | 20 | 104 |
| 3 | Auto | 20 | 70 |
| 4 | Liability and Limits | 13 | 61 |
| 5 | Life | 1 | 18 |
| 6 | Other Key Topics | 11 | 22 |
| 7 | Input Issues/Errors | 2 | 2 |
| Total | | 67 | 277 |

[2] Number of codes = number of {if, else if, else if} blocks of code; count the sample code in { } as 1.
[3] Number of code/sub-code combinations = number of different types of idea created (counts each block within the {if, else if, else if} statements; count the sample code in { } as 3.
FIG. 0

As an example, the first two recommendations in Exhibit 4 (code/sub-codes 200-1 and 200-2) are for a residence with no insurance coverage and relate to the possible loss to the household's personal possessions (household contents) at that residence from fire. 200-1 corresponds to an affordable loss, while 200-2 corresponds to a loss that is not affordable.

Exhibit 5 shows some excerpts (with minor formatting changes) from the C# code that controls the implementation of each of the 277 recommendations, with some helpful hints at the start. So again using the first two recommendations (code/sub-codes 200-1 and 200-2) as an example, for each residence in the household we evaluate whether a total loss of contents appears affordable to the household (affordable meaning a loss is both less than a user defined percentage of future annual household income and another user defined percentage of household net worth). If such a loss is affordable, we create the recommendation with code 200 and sub-code 1, and if not, we create 200-2.

The C# code implementation of the system and method for a particular user will create recommendations similar to those in Exhibits 2 and 4, but customized to the data appropriate to that user, and evaluated using logic including that shown in Exhibit 5 to provide recommendations that are appropriate. For each recommendation code, either zero or one recommendations will be created (per residence, per policy, per individual etc) but not multiple recommendations per residence/per policy/per individual etc. So using code 200 as an example, for a household with two residences, we would generate two ideas, whether each was sub-code 1 or sub-code 2 would depend on whether the total loss of household contents from a fire at each residence was affordable or not for the household.

### DATA INPUTS

Part of Exhibit 1 shows screen shots of what the C# code implementation presents to the user to input the key information for their household. This includes:
Information on the household itself including income, assets, net worth, risk tolerance as a percentage of future annual income and net worth.
Data for the individuals in the household, including any individuals not residing in the household that are financially dependent on the household.
Residences in the household include homes, condominiums and property rented by the household.
Automobiles in the household.
Insurance policies covering household residences.
Insurance policies covering household autos.
Life insurance policies covering individuals in the household.
Umbrella insurance policies protecting the household.

The implementation of the system and method in C# code has similar input screens for the different topics covered.

The data for each page is validated on an element by element basis and where possible the logical consistency of different elements on the same page are also validated. This approach is widely used in most computer systems involving user input.

Specific to this method and system, there are some noteworthy elements to the design:

6.1 (See claim 2). The data for each household is almost completely pre-populated with plausible data, so that if a user creates an account (email+password) and then logs in, they are, for example, able to generate an initial set of recommendations without entering any more data. Exhibit 3 shows the recommendations created in the C# implementation of the system and method for a user (Steve@mf.com) creating an account with email and password, but otherwise not entering any other data. Exhibit 6 shows the data structures, default values and the validation logic for the system and method. For example, absent Steve providing information to the contrary, we assume the net worth of Steve's household is 100,000. The approach is valuable because (a) it conveys information that can best be illustrated by example (b) it is easier to see what's wrong with a recommendation than it is to correctly answer a question (c) users with a short attention span quickly get to some form of conclusion (d) it stops users getting stuck trying to answer a long series of complicated technical questions accurately. As another example, if Steve were to click on add a residence and click on save without further data entry, a home would be created with a 1 Main Street type of generic address (in the household state) and all fields prepopulated for the residence. Absent any further data inputs by Steve, at least one of the recommendations would address the lack of a homeowners insurance policy for this residence.
6.2 (See claim 3). The default data is designed to create recommendations that tend to highlight issues frequently faced by households, so that users entering a minimal amount of data have a good chance of getting a recommendation that is relevant to their real situation. For example, when a user creates an auto insurance policy and adds an auto to it with insurance coverage, it is populated with minimum limits of liability coverage required by the state, which for many people won't be enough. If the user does nothing further, a recommendation will be created on this topic. As another example, if a homeowners policy is created, by default there will be no coverage for flood, wind/hail or earthquake and the recommendations will touch on these areas without the user having done more than create a home and a homeowner's insurance policy.
6.3 (See claim 4). Although most data validation is done when the user enters the data, there are certain validations that are performed when the user runs the model rather than when they enter the data, including (a) the allocation of household income between the individuals in the household and the household itself (for example, interest and dividends that would continue to be received by the household after the death of any one individual in the household); and (b) total assets of the household must be at least as large as the sum of the household net worth and the mortgages on any residences owned by the household. The alternative to this approach using the second example would be to warn the user every time they create a new residence or update an existing one if the logic is breached, which we believe creates an inferior user experience.
6.4 (See claim 5). When performing data validation at the start of creating a set of recommendations for the household, the model corrects the data to something that is plausible and alerts the user to the change rather than taking the user to an input error screen of some sort. No data can be input by the user that will cause the creation of a set of recommendations to fail.
6.5 (See claim 6). Data validation is designed for someone who likes to plan. For example, the date of birth of each individual entered must either be in the past or no more than 9 months in the future, to accommodate a household with a pregnant woman that is planning for the future. As another example, any individuals aged 13 to 19 are required to enter an estimated date for getting a drivers license if they don't already have a drivers license.
6.6 (See claim 7). For a household with multiple insurance policies, it is quite likely that the policy expiration data entered will not be accurate, especially for a user returning to review the recommendations after entering the data some time earlier. The method rolls forward policy expiration dates and creates a recommendation as if each policy were still in force using the appropriate policy term in months or years, and separately creates a recommendation for any expired policy using the actual data input by the user.
6.7 (See claim 8). In the case of policies insuring a residence (homeowners, condo, renters insurance), we create a virtual policy that combines all policies for that residence. For example, someone might buy a homeowners policy protecting their home, but have to buy a separate policy covering earthquake or wind/hail losses, and might have to buy a third policy to protect valuables such as jewelry or silver. We allow the user to enter the 3 policies separately (which is technically slightly better, as an example the policy expirations might not align) or as one policy. In the logic to create recommendations, we combine the multiple policies into one virtual policy and then explore the appropriateness and needs for insurance coverage. This approach improves the user experience since it is easier, for example, to change the valuable articles limit on an existing homeowner's policy than it is to create a whole new valuable articles policy.
6.8 (See claim 9). We remove constraints on the number of items that can be added to a policy that exist with most insurers. One major insurance company until fairly recently issued a separate policy for each auto insured and most insurers limit the number of autos than can be placed on one policy. A user with multiple autos could create one auto policy in our system and method, and add as many autos as existed onto that policy, regardless of the actual number of auto policies with that insurer, simplifying the entry of data.
6.9 (See claim 10). To protect users against mistakenly deleting data that they have entered, we prohibit cascading deletes. For example, to delete an umbrella policy, one first has to delete all insurance policies listed as underlying coverage for that umbrella policy, and remove all individuals listed on the umbrella policy. The alternative would be to allow the deletion of the umbrella policy and at the same time delete the appropriate underlying coverage and named insureds, which we believe is too risky for most users.

### CREATION OF RECOMMENDATIONS—OVERVIEW

Some elements of the system and method for creating recommendations that are noteworthy are:

7.1 (See claim 11). There is a focus on dates to help people get better organized. One part of this is sorting the recommendations by date and assigning the most important recommendations a date in the very near future. The more important part is emphasizing that the fewer and better aligned the dates for policy expiration, the better the chance that the household can organize itself to shop for the most appropriate coverages at a good price. This is done with a series of recommendations around dates and billing, described later.

7.2 (See claim 12). Every recommendation has an indicator showing whether implementation of the recommendation will increase or decrease premium, or leave it more or less unchanged. This makes it easy for users to focus on the two big topics that matter, making sure that coverage that is needed to protect the household is purchased, and saving money where possible. The classification of recommendations into these three groups is generally but not completely clear cut. Some recommendations contain ideas that both increase and reduce coverage, which will increase the premium in some respects and decrease it in others.

7.3 (See claim 13). We do not optimize premium at too granular a level. For example, most auto policies show the premium for combination of auto and coverage (e.g. cost for collision coverage on the 2^{nd} auto is x). We ask for the premium for each policy as a whole because it makes the input of data easier, and because the computation of insurance premiums is so complex, it is almost impossible to definitively model the effect on premiums of any change unless you have full access to the insurance companies systems. Instead, we alert the user to opportunities e.g. your current collision deductible is 100 and it appears that the household can afford a 2,500 deductible which would save money.

7.4 (See claim 14). We show the user an estimate of annual insurance premiums with appropriate caveats. Many households don't have an accurate assessment of their annual insurance expenditures because many non-life policies have terms other than annual, trying to mentally annualize premiums for a mixture of 6, 12 and perhaps 3 month policy terms with different renewal dates is a challenge. A tougher problem is that endorsement activity (reflecting changes to the underlying risk) on any policy makes it very challenging to estimate the current annualized expenditure on insurance since the endorsement premium usually shows the financial effect of the change for only a portion of the full policy term. We alert the user to this issue. We also present annual premium in relation to future household annual income and net worth to be consistent with the structure of the other recommendations.

7.5 (See claim 15). Find the weakest link logic in auto insurance limits. For scenarios where something similar can happen across multiple autos, there's a decision, should we create one recommendation per auto (more detail, but potentially too repetitive), or one recommendation per household (fewer and therefore more concise recommendations, but potentially losing valuable detail)? For auto liability, we chose the one recommendation per household approach, and to try and maximize the value of the recommendations made for injuries to other parties covered by bodily injury coverage and to damage to other parties' property covered by property damage liability, we pick the policy and auto with the smallest limits of liability coverage.

7.6 (See claim 16). User selects household risk tolerance. We provide default values that essentially suggest that a loss is affordable if it is less than both 15% of future household annual income and 7.5% of household net worth, and a financial challenge if not. The user can change both of these percentages based on the risk appetite of the household.

7.7 (See claim 17). For each of the lines of non-life insurance, we use an array of standard deductibles for that line plus the one they have to compute the maximum financially feasible deductible. The recommendations explore the issue of whether the deductible appears to be too high or too low for the household, given its financial situation and appetite for risk.

7.8 (See claim 18). When we simulate liability losses for a situation protected by an insurance policy but not covered by umbrella insurance, we do this by developing a loss that exceeds the combination of the actual underlying insurance policy limit plus a hypothetical low limit umbrella policy, explain the implications to the user with the actual coverage, and then explain how it would be better with the low limit policy in force if the hypothetical umbrella policy was in place.

This approach is more sophisticated than simply modeling a loss slightly in excess of policy limits which may lead to a scenario along the lines of (no umbrella, policy limit 10,000, simulated loss 25,000, user adds umbrella with policy limit of 100,000 and now the simulated loss becomes 250,000—by adding the umbrella it looks like things got worse (their out of pocket expense increased from 15,000 to 140,000), whereas the reality is they now have 100,000 more protection.

7.9 (See claim 19). If we think a recommendation will be made selectively better by departing from what is actually available in the insurance marketplace, we depart. An example would include using hypothetical umbrella policies with smaller limits than generally available and attaching over policies with small underlying limits (which most insurers do not generally allow), to illustrate the financial implications of auto property damage liability losses. We believe that causing 200,000 of damage to expensive equipment and autos in an accident with an underling property damage limit of 5,000 and an umbrella policy with a limit of 100,000 will resonate more than 2,000,000 of damage with limits of 250,000 and 1,000,000 respectively with a user lacking an umbrella policy. A second example would involve personal property coverage under a homeowner's insurance policy, which is often a percentage of the amount for which the dwelling is insured, with the percentage varying from one insurer to another. We focus on what personal property the household actually has at a given residence, and if the coverage afforded by a homeowners policy is too much or too little because of the percentage approach used to design the policy, we comment on that without getting into the percentages and the details of how insurance companies design their products.

7.10 (See claim 20). There are a large number of things that can go wrong with insurance for a household that are detailed in the following pages, things like autos not appearing on any auto policy, individuals missing from umbrella policies where it is not feasible to manually review the declaration pages and other household documents to identify such problems in a reasonable amount of time. This is a factor behind why insurance agents have to purchase errors & omissions insurance to protect themselves. The system and method identifies such problems in the recommendations developed.

7.11 (See claim 21). We encourage users to take a household view of risk, not an insurance product by insurance product view. By developing scenarios for different types of loss and in each scenario standardizing the comparison of losses for non-life policies and loss of household income for life policies to future household annual income and household net worth, we are encouraging people to view the different types of risk faced by the household at one time and through the same lens. We also present the total annual cost of insurance premiums using the same framework. This household view of risk is different from an insurance product by insurance product view of risk and better equips the household to decide what risks will be taken by the household and what will be protected by insurance.

7.12 (See claim 22). Many of the 277 recommendations include a comment on the affordability of a loss. The approach we have have taken splits the description of both affordable losses and non-affordable losses into multiple sub-buckets, for example a non-affordable loss may be a “challenge”, or if it is severe enough, it may be “very difficult”. The more finely tuned the wording, the more human like and the less machine like it is, and we believe that the cumulative effect over many recommendations significantly improves useability. The alternative approach to implementation would be to increase the number of buckets to something significantly more than 277 which we think would create performance and maintenance problems with the system and method and impair its usefulness.

7.13 (See claim 23). We provide more information in the recommendations than in the questions for data inputs, encouraging the user to iterate through the system and method, rather than trying to answer all the questions perfectly and then run the recommendations once. In the C# code implementation, this has the additional benefit that with very long data annotations (the labels for each data element that show up on input screens for each data element), the alignment of data labels and data input boxes starts to deteriorate, whereas long recommendations can be visually presented with no difficulty.

### CREATION OF RECOMMENDATIONS—DETAIL

FIG. 1 shows a screen shot of the overall logic flow to summarize how the ideas are created. The model assumptions are checked for consistency, if appropriate, and then the major areas of interest are explored sequentially. Some categories are combined (billing and agent/insurer recommendations are combined into Other Key topics for brevity), while others (Auto and Residence) create recommendations in multiple categories (Auto/Liability and Limits & Property/Liability & Limits respectively) as the insurance policies cover quite different types of loss. This is necessary to present the conclusions with a household centric view rather than an insurance product centric view.

### CHECK MODEL ASSUMPTIONS

FIG. 2 shows a screen shot of the system and method in this area:

In FIG. 2, for performance reasons, if the user has not edited the data since the last set of recommendations were run (DataClean=true) and if the code has been run earlier in the same day (no need to update policy expiration dates), we skip the validation of model assumptions. Otherwise, we update the projected policy expiration dates for all policies.

In FIG. 3, if have not exited the validation of model assumptions as described and shown in FIG. 2, and if the user has changed their data after the last set of recommendations was generated (DataClean=false), we test for two potential data problems (inconsistent allocation of household income and inconsistent household net worth and total assets) and if appropriate, adjust the underlying data and create recommendations alerting the user to the adjustments that have been made.

### RECOMMENDATION—RESIDENCE—CODE CATEGORY 2 (PROPERTY, CODE 200, 201 ETC) AND CODE CATEGORY 4 (LIABILITY AND LIMITS, CODE 400, 401 ETC)

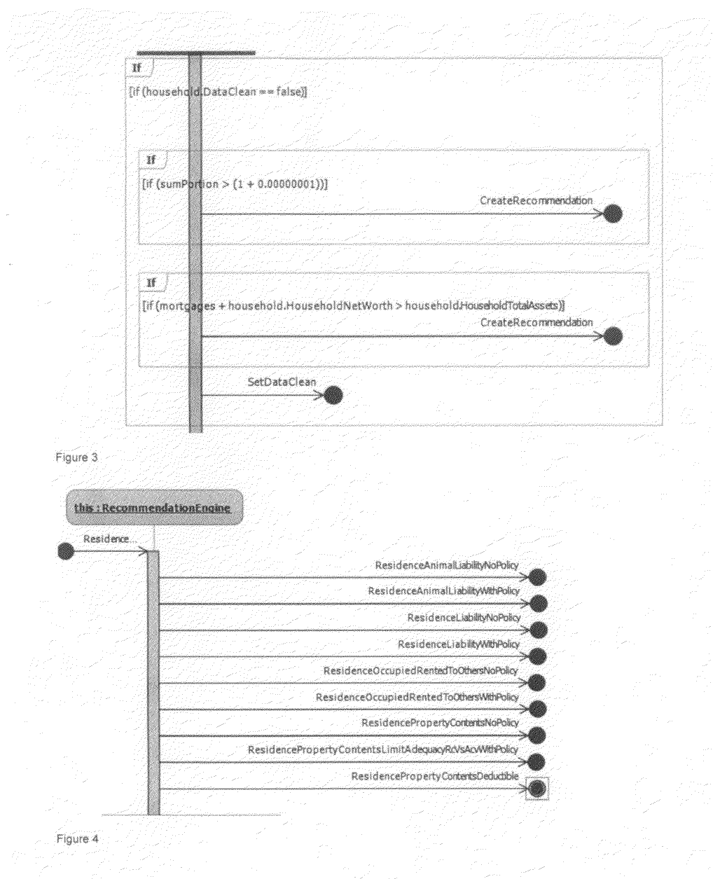

To create recommendations relating to residences in the household, FIGS. 4 and 5 show screen shots of program flow where a variety of possible liability and property losses are explored and recommendations developed.

As an example of one of these, FIG. 6 shows the flow for the start of recommendation code 403, slip and fall losses at a residence where there is an insurance policy for the residence (ResidenceLiabilityWithPolicy).

Here the underlying logic loops through the household residence, and for each questions whether the residence is a rental with a renter's policy. If yes, the code looks at the four permutations of whether there is an umbrella policy (polUU==null means no umbrella, polUU!=null means there is one) and whether or not a loss is affordable to the household. An array of losses ranging from 10,000 to 20,000,000 is selected. If there is an umbrella policy, the smallest loss in the array that exceeds the sum of the limit on the renter's policy and the limit of the umbrella policy is selected. If there is no umbrella policy, the smallest loss in the array that exceeds the sum of the limit on the renter's policy and a hypothetical umbrella policy with a 500,000 limit is selected. Depending on which of the four scenarios (umbrella=yes/no, financial affordable=yes/no) is appropriate, a recommendation is created for 403-1, 403-2, 403-3 or 403-4. 403-5 through 403-8 cover slip and fall accidents for homes with a homeowner policy, and 403-9 through 403-12 cover slip and fall accidents in condos with condo policies. In the case of both condos and rental policies, there is potentially other insurance that can cover a loss, from a condo master policy or from a landlord type policy. For this reason, we generally separate the recommendations for the different residence types.

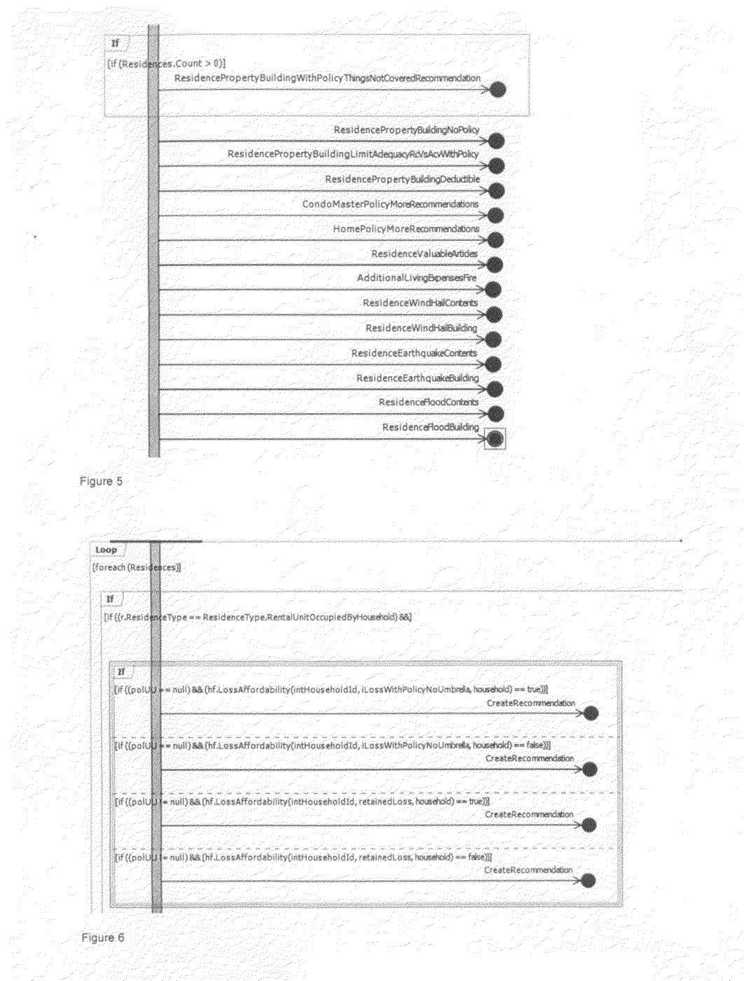

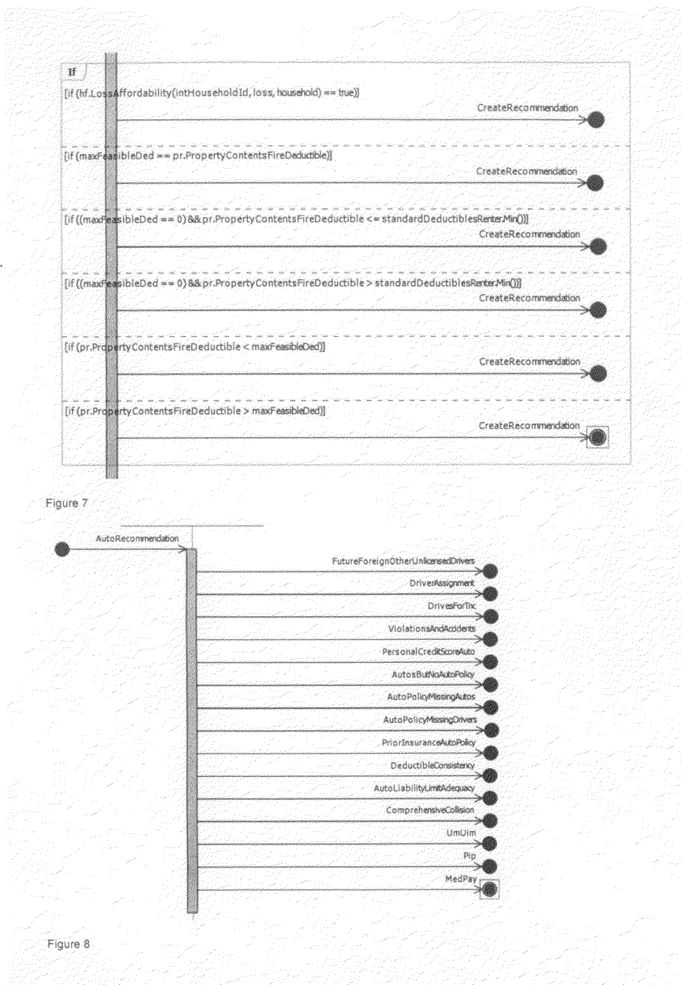

As a second example, FIG. 7 shows the logic underpinning recommendation code/sub-code 202-1 through 202-6, for a residence with a policy, what is the optimal property contents deductible? The general approach is to recommend saving the premium with a larger deductible if a loss appears affordable, and increasing coverage by lowering the deductible if not. If the underlying loss with no policy at all is affordable, we create 202-1. If not, and the maximum financially feasible deductible is equal to the current deductible, we create recommendation 202-2. If nothing is affordable (maxFeasibleDed=0) and the current deductible does not exceed the smallest of the standard deductibles, we create recommendation 202-3. Three more sub codes corresponding to 202-4 through 202-6 complete the scenarios examined.

Referring to FIG. 4 again, ResidenceAnimalLiabilityNoPolicy creates recommendations around dog bite claims for a residence with a dog and no policy. ResidenceAnimalLiabilityWithPolicy does the same thing where there is an insurance policy, and considers situations both with and without an umbrella policy using logic described in section 7.8. We've covered ResidenceLiabilityWithPolicy, ResidenceLiabilityNoPolicy covers residence liability claims where there is no insurance policy providing protection. ResidenceOccupiedRenterToOthersNoPolicy and ResidenceOccupiedRentedToOthersWithPolicy cover the situation where the household rents out space to others using AirBnb/Homeaway or other hotel-substitute sharing programs, either with or without an insurance policy.

ResidencePropertyContentsNoPolicy, covers losses to household goods and possessions with no policy.

ResidencePropertyContentsLimitAdequacyRcVsAcvWithPolicy covers residences with an insurance policy and comments on differences between replacement cost coverage and actual cash value coverage, and the limit of coverage in relation to the value of contents at the residence. ResidencePropertyContentsDeductible covers a residence with a policy and considers the affordability of different deductibles and no property coverage at all for household contents and makes an appropriate recommendation.

Returning to FIG. 5, ResidencePropertyBuildingWithPolicyThingsNotCoveredRecommendation comments on generally uninsurable perils to a building, such as nuclear related damages and a host of other things. ResidencePropertyBuildingNoPolicy covers losses to building (for a home) or building fixtures (for a condo with a bare walls master policy) where there is no insurance policy for the unit.

ResidencePropertyBuildingLimitAdequacyRcVsAcvWithPolicy explores differences between replacement cost coverage and actual cash value coverage for a building with a policy and considers differences, if any, between the replacement cost of the building and the amount of insurance. ResidencePropertyBuildingDeductible considers the affordability of fire losses to the building/building fixtures with different deductibles and no coverage at all. CondoMasterPolicyMoreRecommendations deals with the possibility that there is no condo master policy and with situations where earthquake, wind/hail and flood are not covered perils under the Master Policy for the entire condominium building. HomePolicyMoreRecommendations, deals with a collection of issues that may be present with a homeowner's policy—extended or guaranteed replacement cost coverage, building ordinance coverage, other permanent structures coverage and the implications of a coinsurance clause for fire and related peril losses. ResidenceValuableArticles deals with possible losses of household jewelry, silver and other valuables. AdditionalLivingExpensesFire deals with coverage for temporary housing and similar expenses if a covered residence is destroyed in a fire.

ResidenceWindHailContents and ResidenceWindHailBuilding deal with possible losses to household contents and to the building from wind/hail.

ResidenceEarthquakeContents and ResidenceEarthquakeBuilding do the same things for earthquake related losses, and ResidenceFloodContents and ResidenceFloodBuilding do the same thing for flood losses.

### RECOMMENDATION—AUTO—CODE CATEGORY 3 (AUTO, CODE 300, 301 ETC) AND CODE CATEGORY 4 (LIABILITY AND LIMITS, CODE 400, 401 ETC)

A variety of topics within auto insurance are evaluated, as summarized in FIG. 8:

As an example, code/sub-codes 312-1 through 312-3 and AutoPolicyMissingAutos explore the scenario where there is at least one auto policy and at least one uninsured auto in the household. The three sub-codes differentiate according to whether the uninsured autos are all in states where the purchase of auto insurance is mandatory, are all in states where the purchase of auto insurance is optional, or are in both, as depicted in FIG. 9.

Returning to FIG. 8, FutureForeignOtherUnlicensedDrivers covers future drivers (those expecting to get a US drivers license in the future, but without one at present), drivers with a foreign driver's license but lacking a US driver's license and other household members of driving age lacking a drivers license. DriverAssigment covers the implications of how insurers assign drivers to vehicles when there are at least two of each, DrivesForTnc covers situations where the driver drives for a transportation network company (Uber, Lyft, Sidecar etc), ViolationsAndAccidents covers auto violations and auto accidents in the household, PersonalCreditScoreAuto covers the use of insurance credit scores to determine auto premiums. AutosButNoAutoPolicy deals with the situation where there is at least one auto in the household but no auto policy, considering whether auto insurance is mandatory in the particular state(s) and whether the vehicle is leased or financed (lessors and lenders would generally require auto insurance). We covered AutoPolicyMissingAutos above, where one or more autos are not listed on an auto policy in the household. AutoPolicyMissingDrivers does the same sort of thing for drivers that likely should be listed on an auto policy but are not.

PriorinsuranceAutoPolicy considers the implications of what prior auto insurance was present when the household first bought its auto insurance with the current insurer, in most states this has a significant effect on the premium charged. DeductibleConsistency considers the consistency of comprehensive and collision deductibles for the different insured autos in the household.

AutoLiabilityLimitAdequacy considers the adequacy of limits, taking into account umbrella coverage. ComprehensiveCollision explores the need for these coverages at all, and what the largest deductible might be for the household to reduce premiums but at the same time keep a loss affordable. UmUim explores uninsured motorists and underinsured motorists coverage, in some states this is required and in others not. Pip does something similar for personal injury protection coverage, and MedPay does something similar for medical payments coverage.

### RECOMMENDATION—LIABILITY AND LIMITS—CODE 4 (CODES 400, 401 ETC)

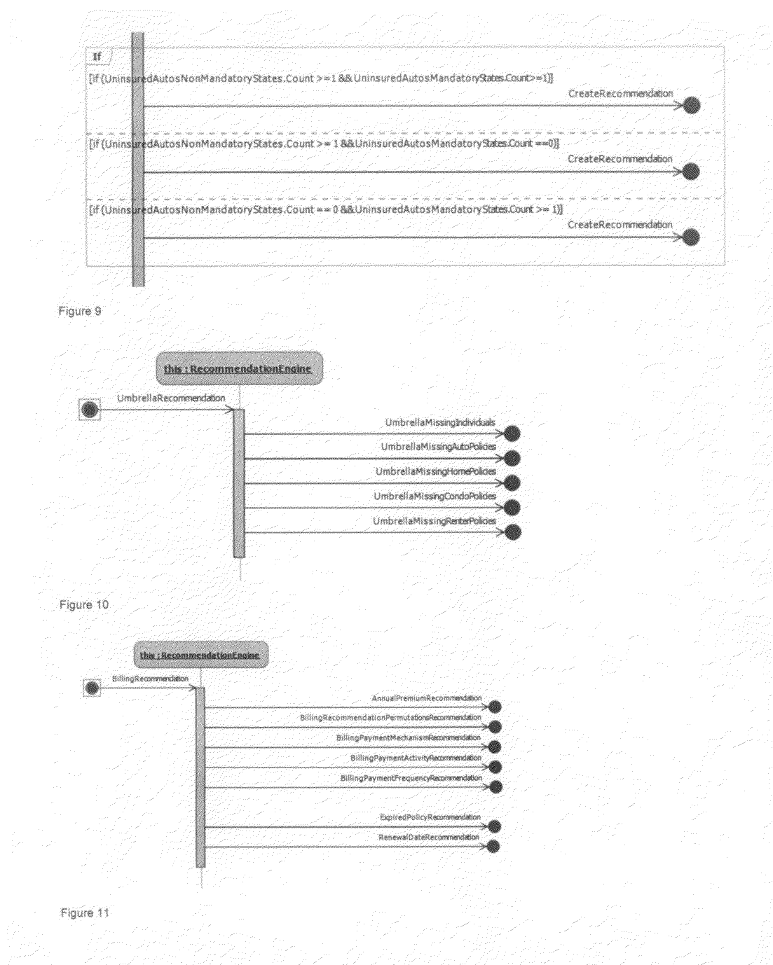

FIG. 10 shows a summary of the topics that are explored with respect to umbrella policies. The simulation of large losses where umbrella coverage is valuable occurs in the recommendations that are developed with the underlying coverage, including the generation of scenarios where the limit of coverage under the umbrella policy is insufficient to cover the underlying loss. The topics here focus on things missing from the umbrella policy, either people are missing or underlying policies are missing, or both.

### RECOMMENDATION—LIFE (CODE 500, 501 ETC)

The logic to develop recommendations relating to life insurance for each individual in the household is contained towards the end of Exhibit 8 (500-1 through 500-18) with the eighteen categories covering the permutations of:
age (less than 75 or not)
no life insurance on individual/life insurance on individual and all term life/life insurance on individual some of which is not term life
1 individual in household/more than 1 individual in household and household income declines on their death/more than 1 individual in household and household income does not decline on their death

For each of the 18 scenarios, a recommendation is generated.

### RECOMMENDATION—CODE 6—OTHER KEY TOPICS—CODE CATEGORY 6 (CODES 600, 601 ETC)

FIG. 11 shows a summary of billing related recommendations. Annual premium as a percentage of household income is developed with supporting recommendations. The number of permutations of how policies are billed and then more detail on the payment mechanism (e.g. credit card), the payment activity (e.g. physical trip to an agent's office) and the payment frequency (e.g. monthly) are compared across all household policies. Expired policy logic creates recommendations around policies that are no longer in force using the expiration date entered by the user, pointing out the lack of coverage. Finally renewal date recommendations develops a list of household policies where every policy in the household has a renewal date that coincides with one of these policies, ideally there would be only one policy in the household on this list and all other household policies would have renewal dates that matched with a renewal of the listed policy.

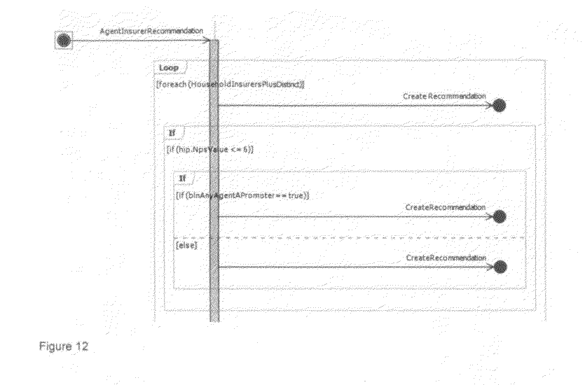

The agent and insurer logic shown above in FIG. 12 uses net promoter scores for each agent and insurer in the household, measuring the degree to which the household would recommend each to a friend or colleague. This information is used to identify possible solutions if not all are liked. For example, if the household likes an insurer but doesn't like the agent it uses, it may be able to keep its coverages with the current insurer and using a broker of record letter, replace the unloved agent with another agent representing the same insurer.

### SYSTEM PERFORMANCE

| | | | Duration To | | |
|---|---|---|---|---|---|
| | | Duration To | Check Model | Duration To | Duration To |
| | Duration All | Create Objects | Assumptions | Create Ideas | Finalize |
| Hhold | Milliseconds | Milliseconds | Milliseconds | Milliseconds | Milliseconds |
| 1 | 1244 | 353 | 381 | 368 | 140 |
| 2 | 1264 | 129 | 462 | 241 | 431 |
| 3 | 605 | 93 | 241 | 111 | 158 |
| 4 | 415 | 96 | 96 | 111 | 111 |
| 5 | 719 | 96 | 223 | 176 | 223 |
| 6 | 642 | 111 | 193 | 145 | 192 |
| 7 | 1323 | 96 | 700 | 202 | 323 |
| 8 | 1298 | 93 | 408 | 358 | 438 |
| 9 | 430 | 83 | 98 | 98 | 150 |
| 10 | 435 | 80 | 168 | 103 | 83 |
| 11 | 308 | 67 | 98 | 0 | 142 |
| 12 | 181 | 67 | 31 | 15 | 67 |
| 13 | 215 | 83 | 36 | 0 | 96 |
| 14 | 212 | 88 | 31 | 15 | 78 |
| 15 | 225 | 83 | 49 | 0 | 93 |
| 16 | 317 | 127 | 96 | 15 | 78 |
| 17 | 241 | 96 | 64 | 0 | 80 |
| 18 | 241 | 96 | 33 | 15 | 96 |
| 19 | 236 | 80 | 46 | 0 | 109 |
| 20 | 223 | 96 | 31 | 0 | 96 |
| 21 | 228 | 96 | 51 | 0 | 80 |
| 22 | 239 | 96 | 46 | 0 | 96 |
| 23 | 496 | 80 | 174 | 15 | 225 |
| 24 | 332 | 80 | 127 | 15 | 109 |
| 25 | 446 | 96 | 176 | 15 | 158 |
| 26 | 1023 | 96 | 303 | 270 | 353 |
| 9 | 896 | 400 | 15 | 350 | 129 |
| Avg 1-26 | 521 | 102 | 168 | 88 | 162 |
| Avg 1-6 | 815 | 146 | 266 | 192 | 209 |
| 2nd 9 − 1st 9 | 466 | 317 | −83 | 252 | −21 |

FIG. 13

The data above show some performance metrics for creating the recommendations using C# code on a not very new Windows laptop (Intel i3-370M, 4GB RAM) using Visual Studio 2012 and a MySQL database (a tangible memory device of sorts). Generally, a set of recommendations is created in about one second (1000 milliseconds) for a household. Households 1-6 are more typical than households 7, 8 and 10-26 and show an average of just over 0.8 seconds. Household 9 is Lucy, whose recommendations are shown in Exhibits 1 and 2, was run twice, the 2^{nd} time not benefiting from objects created by running recommendations for other households shortly before, but benefiting from optimizations in the code to check model assumptions described earlier. We believe that the performance is good enough to make the system and method very usable in the real world.

### SOURCE CODE FOR METHOD AND SYSTEM

ASCII text files have been provided on CD in IBM-PC format created using MS-Windows 7. These were originally created using MS Visual Studio 2012. Four subdirectories of the CD contain the files and the following table lists the subdirectory, file names, date created and size in bytes:

| Sub- | | Date of | Size in |
|---|---|---|---|
| directory | File Name | Creation | Bytes |
| Controllers | AccountController.cs | Feb. 11, 2015 | 16,858 |
| Controllers | AutoController.cs | Feb. 11, 2015 | 5,827 |
| Controllers | ErrorController.cs | Feb. 11, 2015 | 1,221 |
| Controllers | HomeController.cs | Feb. 11, 2015 | 1,427 |
| Controllers | Household.cs | Sep. 30, 2014 | 1,001 |
| Controllers | HouseholdAgentController.cs | Feb. 11, 2015 | 4,405 |
| Controllers | HouseholdController.cs | Feb. 11, 2015 | 2,491 |
| Controllers | HouseholdlnsurerController.cs | Feb. 11, 2015 | 2,245 |
| Controllers | IdeaController.cs | Feb. 11, 2015 | 4,173 |
| Controllers | IdeaTemplateController.cs | Feb. 10, 2015 | 3,449 |
| Controllers | Individual.cs | Sep. 30, 2014 | 890 |
| Controllers | IndividualController.cs | Feb. 11, 2015 | 7,379 |
| Controllers | KnowledgeController.cs | Feb. 11, 2015 | 3,909 |
| Controllers | MyInfoController.cs | Feb. 11, 2015 | 9,576 |
| Controllers | PolicyAutoControllers.cs | Feb. 11, 2015 | 10,158 |
| Controllers | PolicyAutoCoverageController.cs | Feb. 11, 2015 | 7,572 |
| Controllers | PolicyAutoDriverController.cs | Feb. 11, 2015 | 7,352 |
| Controllers | PolicyCondoController.cs | Feb. 11, 2015 | 10,153 |
| Controllers | PolicyHomeController.cs | Feb. 11, 2015 | 9,919 |
| Controllers | PolicyLifeController.cs | Feb. 11, 2015 | 7,179 |
| Controllers | PolicyRenterController.cs | Feb. 11, 2015 | 10,058 |
| Controllers | PolicyUmbrellaController.cs | Feb. 11, 2015 | 10,562 |
| Controllers | PolicyUmbrellaIndividualController. | Feb. 11, 2015 | 7,207 |
| | cs | | |
| Controllers | PolicyUmbrellaUnderlyingController. | Feb. 11, 2015 | 8,440 |
| | cs | | |
| Controllers | ResidenceController.cs | Feb. 11, 2015 | 8,914 |
| Controllers | StateInfoController.cs | Feb. 11, 2015 | 3,602 |
| Controllers | TermConditionController.cs | Feb. 11, 2015 | 5,932 |
| Controllers | Vehicles.cs | Sep. 30, 2014 | 750 |
| Controllers | ViolationAccidentController.cs | Feb. 11, 2015 | 5,663 |
| Migrations | Configuration.cs | Feb. 11, 2015 | 79,651 |
| Models | AccountModel.cs | Feb. 7, 2015 | 2,686 |
| Models | Auto.cs | Feb. 11, 2015 | 3,939 |
| Models | AutoManufacturer.cs | Feb. 11, 2015 | 860 |
| Models | ErrorWebsite.cs | Feb. 11, 2015 | 919 |
| Models | Household.cs | Feb. 11, 2015 | 5,634 |
| Models | HouseholdAgent.cs | Feb. 7, 2015 | 1,044 |
| Models | HouseholdInsurer.cs | Feb. 11, 2015 | 1,177 |
| Models | HouseholdPolicyStandardForm.cs | Feb. 11, 2015 | 1,164 |
| Models | Idea.cs | Feb. 11, 2015 | 1,851 |
| Models | IdeaEngineLog.cs | Feb. 11, 2015 | 1,884 |
| Models | IdeaGroup.cs | Feb. 11, 2015 | 766 |
| Models | IdeaTemplate.cs | Feb. 11, 2015 | 1,015 |
| Models | Individual.cs | Feb. 11, 2015 | 8,472 |
| Models | Insurer.cs | Feb. 11, 2015 | 1,573 |
| Models | Knowledge.cs | Feb. 11, 2015 | 1,050 |
| Models | MyInfo.cs | Feb. 11, 2015 | 2,303 |
| Models | Nps.cs | Jan. 1, 2015 | 609 |
| Models | PatentDbContext.cs | Feb. 11, 2015 | 2,148 |
| Models | Policy.cs | Feb. 11, 2015 | 2,693 |
| Models | PolicyAuto.cs | Feb. 11, 2015 | 3,027 |
| Models | PolicyAutoCoverage.cs | Feb. 11, 2015 | 12,524 |
| Models | PolicyAutoDriver.cs | Feb. 11, 2015 | 1,327 |
| Models | PolicyCondo.cs | Feb. 11, 2015 | 5,529 |
| Models | PolicyExpiration.cs | Feb. 11, 2015 | 596 |
| Models | PolicyHome.cs | Feb. 11, 2015 | 8,192 |
| Models | Policylife.cs | Feb. 11, 2015 | 2,755 |
| Models | PolicyNonLife.cs | Feb. 11, 2015 | 2,071 |
| Models | PollcyNonLifeUnderlying.cs | Feb. 11, 2015 | 745 |
| Models | PolicyRenter.cs | Feb. 11, 2015 | 2,334 |
| Models | PolicyResidence.cs | Feb. 11, 2015 | 8,755 |
| Models | PolicyResidenceOwned.cs | Feb. 11, 2015 | 8,127 |
| Models | PolicyUmbrella.cs | Feb. 11, 2015 | 2,148 |
| Models | PolIcyUmbrellaIndividual.cs | Feb. 11, 2015 | 1,238 |
| Models | PolicyUmbrellaUnderlying.cs | Feb. 11, 2015 | 1,897 |
| Models | Residence.cs | Feb. 11, 2015 | 5,438 |
| Models | SessionData.cs | Feb. 11, 2015 | 1,047 |
| Models | StateInfo.cs | Feb. 11, 2015 | 2,835 |
| Models | SuperUser.cs | Feb. 7, 2015 | 328 |
| Models | TermCondition.cs | Feb. 11, 2015 | 1,005 |
| Models | TermConditionLog.cs | Jan. 3, 2015 | 804 |
| Models | ViolationAccident.cs | Feb. 11, 2015 | 2,072 |
| View- | AgentInsurer.cs | Feb. 11, 2015 | 12,906 |
| Models | | | |
| View- | Auto.cs | Feb. 11, 2015 | 159,744 |
| Models | | | |
| View- | Billing.cs | Feb. 11, 2015 | 55,343 |
| Models | | | |
| View- | HelperFunction.cs | Feb. 11, 2015 | 67,966 |
| Models | | | |
| View- | IdeaEngine.cs | Feb. 11, 2015 | 9,347 |
| Models | | | |
| View- | Life.cs | Feb. 11, 2015 | 24,550 |
| Models | | | |
| View- | ModelAssumptions.cs | Feb. 11, 2015 | 11,132 |
| Models | | | |
| View- | Repository.cs | Feb. 11, 2015 | 10,237 |
| Models | | | |
| View- | Residence.cs | Feb. 11, 2015 | 251,881 |
| Models | | | |
| View- | Umbrella.cs | Feb. 11, 2015 | 18,037 |
| Models | | | |

What is claimed is:

1. An insurance recommendation computer system and method consisting of computer hardware and software that provides a user interface for a user to enter information about their household that is relevant for the development of insurance recommendations for that household, a data structure to validate and store the information, and a method for developing insurance recommendations and presenting them to the user.

2. The method of claim 1 further comprising almost completely prepopulating data for each household with plausible data, so for example if a user creates an account (email+password) and then logs in, they are able to generate an initial set of recommendations without entering any more data.

3. The method of claim 1 further comprising using default data selected to create recommendations that tend to highlight issues frequently faced by households.

4. The method of claim 1 further comprising performing most data validation when the user enters the data, but performing certain validations when the user creates the recommendations.

5. The method of claim 1 further comprising correcting problematic data to something that is plausible when creating recommendations and alerting the user to what has been done.

6. The method of claim 1 further comprising employing data validation with a focus on someone who likes to plan.

7. The method of claim 1 further comprising anticipating that policy expiration dates are likely to be incorrect when recommendations are generated and both rolling them forward and alerting the user to the implications of an expired policy in developing recommendations.

8. The method of claim 1 further comprising combining multiple policies insuring one residence (homeowners, condo, renters insurance) into one virtual policy where appropriate.

9. The method of claim 1 further comprising removing the constraints on the number of items that can be added to a policy that exist with most insurers.

10. The method of claim 1 further comprising protecting users against mistakenly deleting data that they have entered, prohibiting cascading deletes.

11. The method of claim 1 further comprising focusing on dates to help people get better organized.

12. The method of claim 1 further comprising producing indicators showing whether implementation of the recommendation will increase or decrease premium, or leave it more or less unchanged.

13. The method of claim 1 further comprising not optimizing premium at too granular a level.

14. The method of claim 1 further comprising showing the user an estimate of annual insurance premiums with an appropriate caveat about endorsement activity distorting the calculation.

15. The method of claim 1 further comprising using “find the weakest link” logic in auto insurance limits.

16. The method of claim 1 further comprising allowing the user to select household risk tolerance.

17. The method of claim 1 further comprising using for each of the lines of non-life insurance where a policy is present, an array of standard deductibles plus the one they have to compute the maximum financially feasible deductible.

18. The method of claim 1 further comprising that when simulating liability losses for a situation protected by an insurance policy but not covered by umbrella insurance, developing a loss that exceeds the combination of the actual underlying insurance policy limit plus a hypothetical low limit umbrella policy.

19. The method of claim 1 further comprising selectively departing from what is actually available in the marketplace to better illustrate the recommendations.

20. The method of claim 1 further comprising systematically searching for things that can go wrong with insurance.

21. The method of claim 1 further comprising encouraging users to take a household view of risk, not an insurance product by insurance product view of risk.

22. The method of claim 1 further comprising describing the financial implications of a loss at a more granular level than that implied by 277 recommendation categories.

23. The method of claim 1 further comprising providing more information in the recommendations than in the questions for data inputs, encouraging the user to iterate through the system and method, rather than trying to answer all the questions perfectly and then running the recommendations once.
